(19) United States
(12) Patent Application Publication
(10) Pub. No.: US 2015/0367309 A1
(43) Pub. Date: Dec. 24, 2015

(54) METHOD AND ARRANGEMENT FOR REDUCING AUTOFLASH AND SLURRY CARRYOVER IN AUTOCLAVE FLASH SYSTEMS

(71) Applicant: OUTOTEC (FINLAND) OYJ, Espoo (FI)

(72) Inventor: John O'CALLAGHAN, Wendouree (AU)

(73) Assignee: Outotec (Finland) Oy, Espoo (FI)

(21) Appl. No.: 14/766,221

(22) PCT Filed: Feb. 7, 2014
(86) PCT No.: PCT/FI2014/050090

§ 371 Date: Aug. 6, 2015

(30) Foreign Application Priority Data
Feb. 8, 2013 (FI) 20135118

(51) Int. Cl. B01J 3/04; C22B 3/04

(52) U.S. Cl. CPC B01J 3/04; C22B 3/04

(57) ABSTRACT

The present invention relates to a method and an arrangement for pressure and temperature let down of autoclave discharge slurry, in particular in pressure oxidation or high pressure acid leach of metal containing ore. The method of the invention comprises a step of precooling the autoclave discharge slurry by contacting the autoclave discharge slurry with a cooling fluid for reducing the temperature of the autoclave discharge slurry prior to its entry into the first flash stage. The invention further relates to an autoclave (1) and pressure let-down arrangement adapted for providing cooling fluid to the autoclave discharge slurry prior its entry into the first flash vessel (2).

### FIELD OF THE INVENTION

The present invention relates to method and an arrangement for pressure and temperature let down of autoclave discharge slurry, in particular in pressure leaching or oxidation of metal containing ore or concentrate.

### BACKGROUND OF THE INVENTION

In extractive metallurgy autoclaves are used for increasing operating temperature. Once ore or concentrate has been leached the discharge of the autoclave is often reduced in temperature and pressure by allowing the autoclave discharge slurry to flash i.e. convert the heat of the slurry at high temperature into a flash steam. To reduce capital costs in gold and base metal autoclave operations the number of flash stages is minimised. However, as a result the pressure drop per flash stage is very high and the flashing slurry discharges into the flash tank “explosively” at high velocity and may lead to process instability and excessive wear on the flash equipment. Unfortunately in all flashing operations there is some slurry carryover entrained in the flash steam, however slurry carryover into flash steam is generally higher at higher pressure drops. With excessive carryover it may be difficult and expensive to clean the flash steam to a level acceptable by environmental standards.

Often, as is the case for nickel high pressure acid leaching (HPAL) autoclaves, some flash steam carryover is acceptable since the flash steam is used to pre-heat incoming laterite feed slurry and recycling solids and acid can be tolerated. However for many operations, especially gold concentrate operations, where the energy from the autoclave slurry is let-down in a single stage flash operation significant amounts of slurry carryover arises and the flash-steam must cleaned in some form of cleaning device. Multiple cleaning stages may be required.

### BRIEF DESCRIPTION OF THE INVENTION

An object of the present invention is thus to provide an improved method for pressure and temperature let-down of a pressure oxidation autoclave discharge slurry and an apparatus implementing the method so as to overcome the above problems. The method of the invention comprises a step of precooling the autoclave discharge slurry by contacting the autoclave discharge slurry with a cooling fluid for reducing the temperature of the autoclave discharge slurry prior to its entry into the first flash stage.

The invention further relates to an autoclave and pressure let-down arrangement adapted for providing cooling fluid to the autoclave discharge slurry prior its entry into the first flash vessel.

The objects of the invention are achieved by a method and an arrangement characterized by what is stated in the independent claims. Preferred embodiments of the invention are disclosed in the dependent claims.

### BRIEF DESCRIPTION OF THE DRAWINGS

In the following the invention will be described in greater detail by means of preferred embodiments and with reference to the attached drawings, in which

FIG. 1 shows a conventional autoclave and single stage pressure let-down arrangement;

FIG. 2 shows a first autoclave and single stage pressure let-down arrangement illustrating a first embodiment of the invention;

FIG. 3 shows a second autoclave and single stage pressure let-down arrangement illustrating a second embodiment of the invention;

FIG. 4 shows a third autoclave and single stage pressure let-down arrangement illustrating a third embodiment of the invention.

### DETAILED DESCRIPTION OF THE INVENTION

The present invention relates to pressure let down flash operation as commonly applied for pressure and temperature let-down of autoclave discharge slurry in the metallurgical autoclave industry, in particular pressure leaching or oxidation of gold, copper and other base metal ores and concentrates.

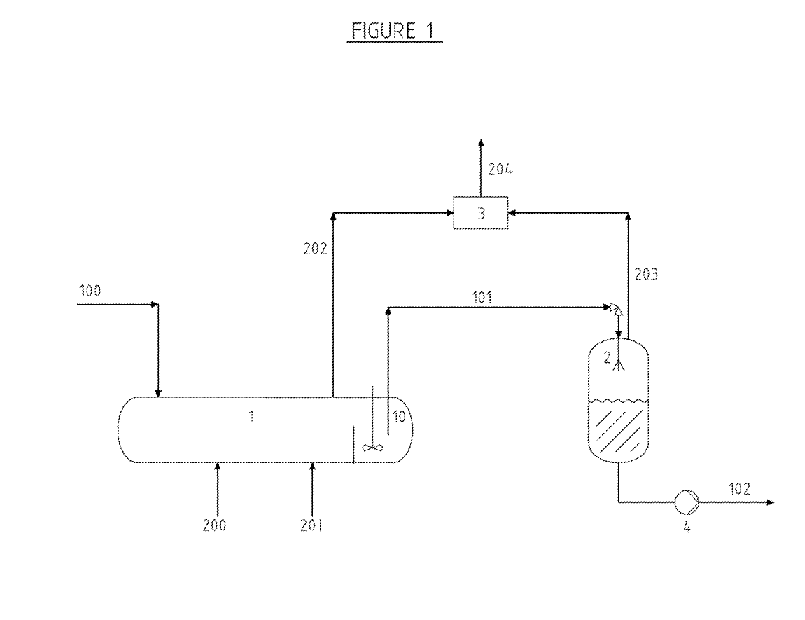

FIG. 1 shows a conventional autoclave and single stage pressure let-down arrangement, arranged for temperature and pressure let-down of autoclave discharge slurry, comprising an autoclave 1 arranged for pressure oxidation or high pressure leaching of metal containing ore or concentrate; a first flash vessel 2 connected to the autoclave 1 for receiving autoclave discharge slurry from the said autoclave and arranged for converting the heat of the autoclave discharge slurry into a first flash steam and a first cooled slurry. With reference to FIG. 1 the autoclave discharge slurry is discharged from the last compartment 10 of the autoclave 1 to the first flash vessel via an autoclave discharge line 101 arranged between the autoclave and the first flash vessel for transferring the autoclave discharge slurry from the autoclave to the first flash vessel. After pressure and temperature let-down in the first flash vessel 2, the cooled slurry is the recovered though the first slurry discharge line 102, and the flash steam is released via a steam line 203. Prior to release to the atmosphere the steam is cleaned in a gas scrubbing unit 3.

In a single stage flash operation such as shown in FIG. 1, the heat of the slurry is let-down in single operational step where pressure drops from up to 6000 kPa to atmospheric pressure are possible. The autoflash pressure difference (AFP), i.e. the difference between the critical pressure of the flashing steam and the downstream pressure, in such operation is positive and choked flow and autoflash will occur.

The critical pressure (P_{cf}) for the flash steam flow can be defined by the relationship below. This relationship is for choked or sonic flow of a compressible gas flow. P₁ is the upstream pressure and is made up of saturation steam pressure and any overpressure that may be present in the system, for example unreacted oxygen, carbon dioxide or other inerts. In the case of flashing slurry, k is the ratio of heat capacities Cₚ/Cᵥ of the steam at the upstream saturated steam pressure at saturation temperature. P₂ is the downstream vessel pressure which is typically atmospheric pressure in single stage arrangements. If P_{cf}>P₂ then the flow is choked and flow cannot exceed the velocity of sound. In the case of flash vessels the difference between P_{cf} and P₂ is defined as the autoflash pressure difference (APF). Autoflash Pressure Difference (AFP)=(P_{cf}−P₂)

$${P}_{cf} = {{P}_{1} [ \frac{2}{k + 1} ]}^{k / ( k - 1 )}$$

Flash vessel operation with largely positive AFP, i.e. over 800 kPa, may lead to significant noise, excessive wear on flash vessel walls, dirty flash steam, process instability and low heating efficiency. Further, the amount of autoflash often defines the quality of flash steam. Hence flash operation in a single stage from high autoclave pressure will generate flash steam with very poor quality. It is not uncommon for flash steam to comprise up to 50% w/w slurry carryover of the flash steam, typically between 1 to 40% w/w.

Cleaning of a flash steam that carries large amounts of slurry may require considerable capital investment with multiple stages of gas cleaning equipment. Excessive solids and slurry carryover in flash steam may also lead to accelerated erosion of pipework and fittings. This in turns leads to either increased maintenance costs and/or increased autoclave downtime.

Minimizing the autoflash pressure difference (AFP) of the system can lead to reduced carryover of slurry in the flash steam. The present invention provides a method for reducing the AFP by reducing the temperature of the incoming autoclave discharge slurry before flashing.

The present invention relates to a method for pressure and temperature let-down of autoclave discharge slurry comprising the steps of (a) providing an autoclave discharge slurry; (b) precooling the autoclave discharge slurry by contacting the autoclave discharge slurry with a cooling fluid for reducing the temperature of the autoclave discharge slurry and thus obtaining a precooled autoclave discharge slurry; (c) receiving the precooled autoclave discharge slurry into a first flash vessel; and (d) obtaining a first flash steam and a first cooled slurry by allowing the autoclave discharge slurry to flash in the first flash vessel. The autoclave discharge slurry is provided by pressure oxidation (or high pressure leaching) of metal containing ore or concentrate in an autoclave.

The term “contacting” as used herein and hereafter in context of the present invention refers to direct contact of the autoclave discharge slurry and the cooling fluid. By addition of cooling fluid the temperature of the slurry going to a flash vessel is substantially reduced. This in turn reduces the amount of autoflash in the system. Thus the method of the invention will reduce explosive flashing in the first flash vessel and provide reduced carryover of slurry in the flash steam, less wear on vessel walls and less noise. The carryover may be reduced from over 40% w/w of slurry of the flash steam to less than 10% w/w, preferably to 1 to 5% w/w. This can be achieved by providing an AFP of 300 to 500 kPa. The present invention also provides means for achieving negative AFP. However this is not necessary for obtaining acceptably low carryover of the slurry in the flash steam.

In an embodiment of the present invention a portion of the first cooled slurry is utilized as the cooling fluid. In this embodiment precooling in step (b) is preferably accomplished by recycling a portion, preferably 10 to 60% w/w, more preferably 20 to 40% w/w, of the obtained first cooled slurry and contacting it with the autoclave discharge slurry for reducing the temperature of the autoclave discharge slurry prior to its entry into the first flash vessel in step (c). The amount of recycle depends on the autoclave conditions and number of flashing stages as well as the temperature of the recycled cooled slurry. The recycled first cooled slurry is preferably contacted with the autoclave discharge slurry outside the autoclave, in particular in an autoclave discharge line arranged between the autoclave and the first flash vessel for transferring the autoclave discharge slurry from the autoclave to the first flash vessel. The temperature of the recycled cooled slurry is typically 95 to 150° C. The AFP the first flash stage, and any further flash stage, is preferably 300 to 500 kPa.

The cooled slurry discharging from a flash vessel typically comprises 5 to 40% w/w solids. Preferably most or all of the solid material is removed from the recycled cooled slurry prior to contacting it with the autoclave discharge slurry. In a preferred embodiment of the method of the invention cooled liquor obtained is utilized as the cooling fluid. The liquor utilized as the cooling fluid preferably comprises <5% w/w solids, more preferably <1% w/w solids. The composition of the liquor is same or similar to the solution leaving the autoclave process. In this embodiment the method of the invention preferably comprises treating the first cooled slurry with a solid/liquid separation device to obtain a first concentrated cooled slurry and first cooled liquor and recycling part or all of the said cooled liquor and contacting it with the autoclave discharge slurry for reducing the temperature of the autoclave discharge slurry before it enters the first flash vessel in step (c). Preferably 10 to 60%, more preferably 20 to 40%, of the obtained first cooled liquor is recycled or as required to achieve the AFP target of 300-500 kPa.

In an alternative embodiment of the present invention the cooling fluid is fresh water, process water or any mixture thereof. Water may be contacted with the autoclave discharge slurry in the autoclave discharge line arranged between the autoclave and the first flash vessel; alternatively it may be contacted with the autoclave discharge slurry before the slurry exits the autoclave. In this embodiment the cooling fluid is preferably provided to the last compartment of the autoclave and contacted with the autoclave discharge slurry in the said last compartment of the autoclave. The temperature of the water added to the last compartment of the autoclave is preferably from 50 to 100° C. or as required to achieve the AFP target of 300-500 kPa.

The autoclaves used in pressure oxidation or high pressure acid leach operations typically operate at a temperature of 90 to 270° C. and thus in accordance with the present invention the temperature of the autoclave discharge slurry prior to precooling may vary within this range. The present invention is particularly suitable for operations where autoclave operates at temperatures over 180° C. The operating pressure of such autoclave is typically between 1000 to 6000 kPa, more suitably between 1000 to 5000 kPa. In the precooling step the temperature of the autoclave discharge slurry is preferably dropped by 5 to 80° C., more preferably 10 to 60° C. The discharge slurry will be let-down in pressure and temperature until it reaches atmospheric pressure. Preferably this is done in a single flash stage to reduce capital cost. However, in accordance with the present invention the arrangement may alternatively comprise two or more flash stages. In is to be noted that the method of the invention provides possibility to minimize the number of flash stages in operations where multiple flash stages have previously been utilized to minimize wear and carryover. The method of the present invention is particularly suited for processes where the pressure drop of each flashing stage is over 800 kPa, in particular over 2500 kPa. When the process comprises several flash stages cooling between a first flash vessel and second flash vessel is also possible, and is further possible between any further stages of flashing.

Thus in a preferred embodiment of the method of the invention the method comprises only one flash stage where the precooled autoclave discharge slurry is allowed to flash in a flash vessel for obtaining flash steam and cooled slurry.

In an alternative embodiment of the method of the invention the method comprises after step (d) a further step of (e) transferring the first cooled slurry to a second flash vessel and obtaining a second flash steam and a second cooled slurry by allowing the first cooled slurry to flash in the second flash vessel. When obtained cooled slurry is utilized as the cooling fluid the method may then further comprise (f) recycling a portion of the obtained second cooled slurry and contacting it with the autoclave discharge slurry for further reducing the temperature of the autoclave discharge slurry before it enters the first flash vessel in step (c). I.e. in a preferred alternative embodiment of the method of the invention the method comprises maximum of two flash stages where the precooled autoclave discharge slurry is allowed to flash in a flash vessel for obtaining flash steam and cooled slurry.

If necessary the method of the present invention may further comprise (g) further cooling the second cooled slurry in one or more further subsequent flash vessels by allowing the slurry obtained from a previous flash vessel to flash in a further flash vessel and thus obtaining a further flash steam and a further cooled slurry. Furthermore, when obtained cooled slurry is utilized as the cooling fluid the method may then further comprise (h) recycling a portion of the obtained further cooled slurry and contacting it with the autoclave discharge slurry for further reducing the temperature of the autoclave discharge slurry before it enters the first flash vessel in step (c). The second and/or further cooled slurry may be treated as discussed above before contacting it with the autoclave discharge slurry.

The arrangement of the invention comprises an autoclave arranged for pressure oxidation (or high pressure acid leaching) of metal containing ore or concentrate; a first flash vessel arranged for converting the heat of the autoclave discharge slurry into a first flash steam and a first cooled slurry and connected to the autoclave for receiving autoclave discharge slurry from the said autoclave; and means for providing and contacting cooling fluid with the autoclave discharge slurry prior to its entry into the first flash vessel.

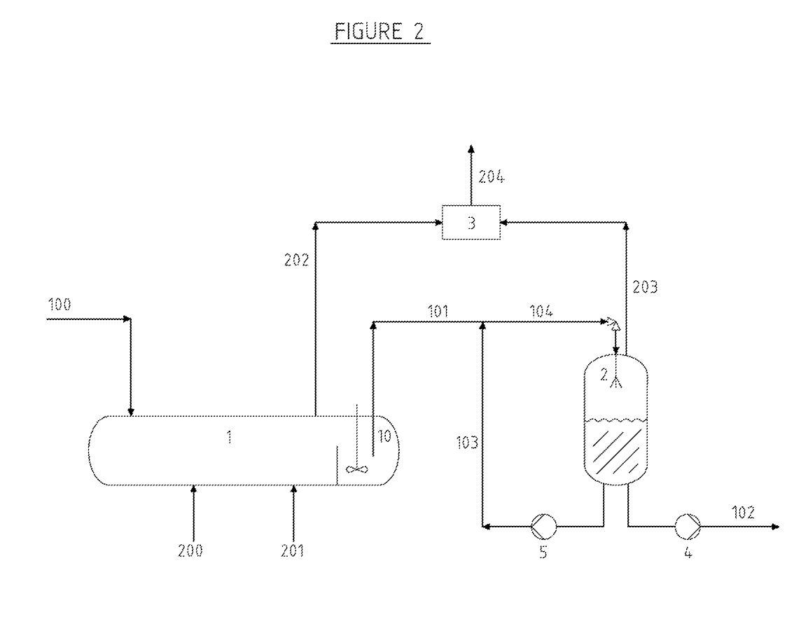

As shown in FIG. 2 as an embodiment of the invention, the first flash vessel may be connected to an autoclave discharge line for precooling the autoclave discharge slurry with a portion of the first cooled slurry. Like components are designated by the same reference numerals as used in FIG. 1.

FIG. 2 shows an autoclave and single stage pressure let-down arrangement, comprising an autoclave 1 arranged for pressure oxidation (or high pressure acid leaching) of metal containing ore or concentrate; a first flash vessel 2 arranged for converting the heat of the autoclave discharge slurry into a first flash steam and a first cooled slurry and connected to the autoclave via an autoclave discharge line 101 for receiving autoclave discharge slurry from the said autoclave; a recycling line 103 connected to the first flash vessel 2 and the autoclave discharge line 101 for providing a portion of the cooled slurry and contacting it with the autoclave discharge slurry prior to its entry into the first flash vessel 2. In accordance with the present invention the volume and the velocity of the autoclave discharge slurry is increased and its temperature is dropped when it is contacted with the recycled cooled slurry and as it enters the latter part 104 of the autoclave discharge line 101.

The recycling line 103 is preferably equipped with a pump 5 for transferring the recycled cooled slurry within the recycling line 103. FIG. 2 shows two separate discharge lines for discharging the first cooled slurry from the first flash vessel 2, i.e. the first slurry discharge line 102 for recovering the first cooled slurry and the recycling line 103 for recycling the portion of the first cooled slurry that is to be contacted with the autoclave discharge slurry.

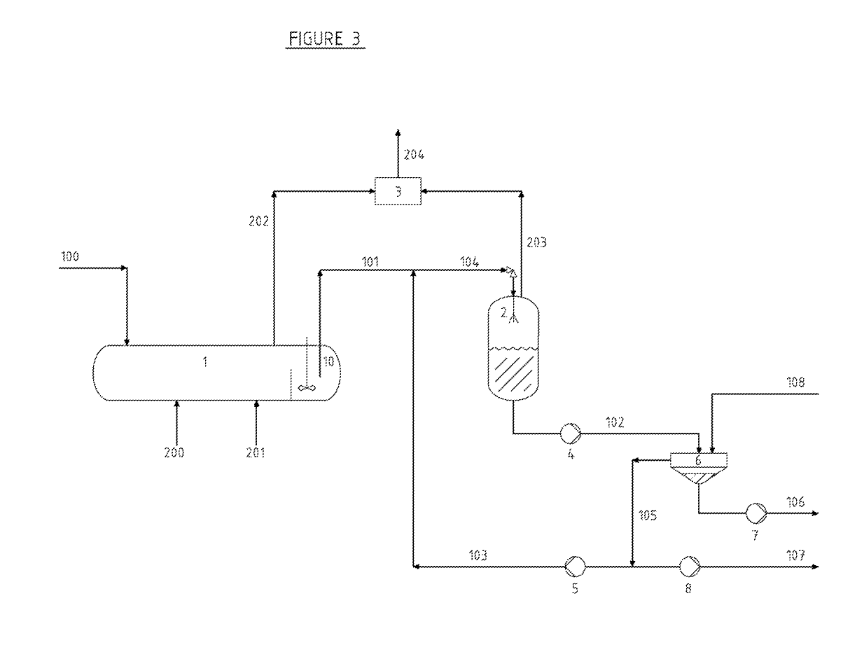

Preferably most or all of the solids comprised in the cooled slurry are removed from the recycled slurry before it is mixed with the autoclave discharge slurry. An embodiment of this type is illustrated in FIG. 3. In FIG. 3, like components are designated by the same reference numerals as used in FIGS. 1 and 2.

In embodiment presented in FIG. 3, the arrangement further comprises a solid/liquid separation device 6 connected to the first flash vessel 2 for receiving the cooled slurry from the said flash vessel and arranged for separating part or all of the solids comprised in the said cooled slurry from the liquids to obtain a first concentrated cooled slurry and first cooled liquor, and further connected to the autoclave discharge line 101 for recycling a portion of the first cooled liquor and contacting it with the autoclave discharge slurry prior to its entry into the first flash vessel 2. The solid/liquid separation device 6 is preferably connected to the first flash vessel via a first slurry discharge line 102.

Referring to FIG. 3 and in accordance the present invention the solid/liquid separating device 6 may be connected to the autoclave discharge line 101 via a slurry liquor discharge line 105 which is divided into a recycling line 103 which is connected to the autoclave discharge line 101 for recycling a portion of the first cooled liquor a portion and contacting it with the autoclave discharge slurry prior to its entry into the first flash vessel 2, and to a liquor recovery line 107 for recovering the remaining portion of the first cooled liquor. The concentrated cooled slurry may be recovered though a line 106. The solid/liquid separating device may optionally be further equipped with a line 108 for providing wash water to the solid/liquid separating devise. Wash water may be used for example to wash solids of leached metals or to wash valuable leached solids of impurity liquor.

Solid/liquid separation devices of the invention include thickeners, filters, centrifuges, cyclones, and any further equipment that a person skilled in the art would find suitable for separating part or all of the solid material from the cooled slurry.

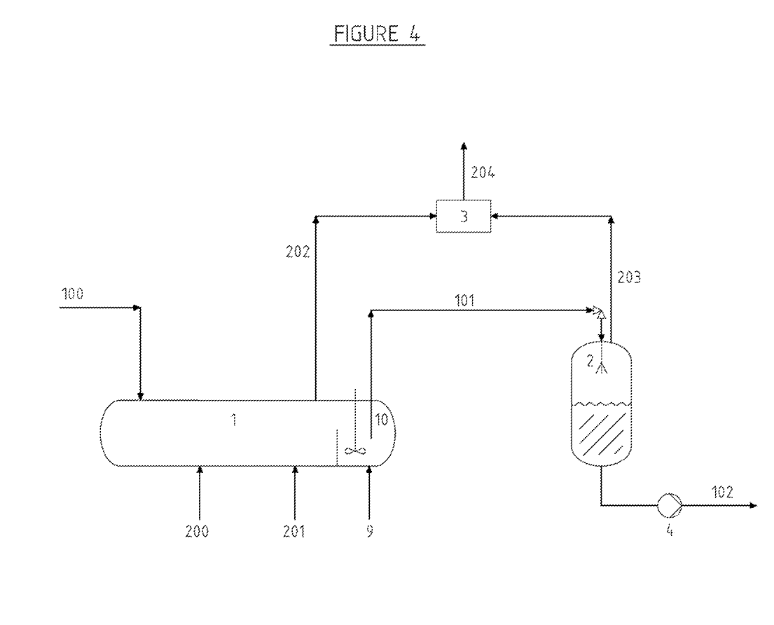

As shown in FIG. 4 as an alternative embodiment of the invention, cooling fluid may also be arranged to be provided to the last compartment of the autoclave. Like components are designated by the same reference numerals as used in FIG. 1.

FIG. 4 shows an autoclave and single stage pressure let-down arrangement, arranged for temperature and pressure let down of autoclave discharge slurry, comprising an autoclave 1 arranged for pressure oxidation or high pressure leaching of metal containing ore or concentrate; a first flash vessel 2 connected to the autoclave 1 for receiving autoclave discharge slurry from the said first autoclave and arranged for converting the heat of the autoclave discharge slurry into a first flash steam and a first cooled slurry; an inlet 9 connected to the last compartment 10 of the autoclave 1 and arranged for providing cooling fluid to the said last compartment 10 for precooling of the autoclave discharge slurry.

Referring to FIGS. 2 to 4, the first flash steam is released from the first flash vessel 2 via a steam line 203. The flash steam may be discarded to the atmosphere and/or utilized elsewhere in the process. Prior to release to the atmosphere the steam may be cleaned in a gas scrubbing unit 3. Referring to FIGS. 2 and 4, the portion of the first cooled slurry that is not recycled may be recovered though the first slurry discharge line 102. Referring to FIG. 3, when the first cooled slurry is treated to obtain the first concentrated cooled slurry and the first cooled liquor the portion of the cooled liquor that is not recycled may be recovered though line 107 and the concentrated cooled slurry may be recovered though line 106.

Any excess autoclave vent steam may be released from the system via an autoclave vent line 202. The excess autoclave vent steam may be utilized elsewhere in the process or be discarded to the atmosphere via steam line 204. Prior to release to the atmosphere the steam may be cleaned in a gas scrubbing unit 3.

### EXAMPLES

### Example 1

The following example illustrates by estimation, with reference to FIG. 2, the effect of recycling a portion of the cooled slurry and contacting it with the autoclave discharge slurry prior to its entry into a first flash vessel in a single stage flash operation.

In this example the autoclave pressure is 2400 kPa (including some oxygen pressure), downstream pressure, i.e. pressure after first flash, is 101.325 kPa. Slurry carryover to flash steam is estimated in two cases: a) no recycle of cooled slurry, b) recycle of cooled slurry and precooling the discharge slurry to 145° C. Results are shown in Table 1.

TABLE 1

| | | | Recycle at |
|---|---|---|---|
| | | No Recycle | AFP 475 |
| Autoclave pressure | kPa | 2400 | 2400 |
| Downstream pressure | kPa | 101.325 | 101.325 |
| AFP | kPa | 1142 | 475 |
| Temperature (after quench) | ° C. | 205 | 145 |
| Estimated carryover due to autoflash | % w/w | 25-50 | 1-5 |

As shown in Table 1 carryover in a single stage flash operation could be reduced from between 25 to 50% w/w to between 1 to 5% w/w by cooling the autoclave discharge slurry by contacting in with cooled slurry (or any cool liquid) prior to its entry into the first flash stage.

It will be obvious to a person skilled in the art that, as the technology advances, the inventive concept can be implemented in various ways. The invention and its embodiments are not limited to the examples described above but may vary within the scope of the claims.

1.-16. (canceled)

17. A method for pressure and temperature let down of autoclave discharge slurry, characterized in that the method comprises:
(a) providing an autoclave discharge slurry;
(b) precooling the autoclave discharge slurry by contacting the autoclave discharge slurry with a cooling fluid by addition of the cooling fluid for reducing the temperature of the autoclave discharge slurry and thus obtaining a precooled autoclave discharge slurry;
(c) receiving the precooled autoclave discharge slurry into a first flash vessel; and
(d) obtaining a first flash steam and a first cooled slurry by allowing the autoclave discharge slurry to flash in the first flash vessel.

18. The method as claimed in claim 17, wherein an autoflash pressure difference in the first flash vessel is 300 to 500 kPa.

19. The method as claimed in claim 17, wherein a portion of the first cooled slurry is utilized as the cooling fluid.

20. The method as claimed in claim 17, wherein precooling in step (b) is accomplished by recycling a portion of the obtained first cooled slurry into the autoclave discharge slurry for reducing the temperature of the autoclave discharge slurry prior to its entry into the first flash vessel in step (c).

21. The method as claimed in claim 20, wherein 10 to 60% w/w of the obtained first cooled slurry is recycled.

22. The method as claimed in claim 19, wherein the first cooled slurry is contacted with the autoclave discharge slurry in an autoclave discharge line arranged between an autoclave and the first flash vessel for transferring the autoclave discharge slurry from the autoclave into the first flash vessel.

23. The method as claimed in claim 19, wherein the method comprises treating the first cooled slurry with a solid/liquid separation devise to obtain a first concentrated cooled slurry and first cooled liquor and recycling part or all of the said cooled liquor and contacting it with the autoclave discharge slurry for reducing the temperature of the autoclave discharge slurry before it enters the first flash vessel in step (c).

24. The method as claimed in claim 17, wherein the cooling fluid is fresh water, process water or any mixture thereof.

25. The method as claimed in claim 17, wherein the method comprises providing cooling fluid to the last compartment of the autoclave and contacting it with the autoclave discharge slurry in the said last compartment of the autoclave.

26. The method as claimed in claim 17, wherein the temperature of the autoclave discharge slurry is reduced by 5 to 80° C.

27. An autoclave and pressure let-down arrangement, comprising an autoclave arranged for pressure oxidation or high pressure acid leaching of metal containing ore or concentrate; a first flash vessel arranged for converting the heat of the autoclave discharge slurry into a first flash steam and a first cooled slurry and connected to the autoclave for receiving autoclave discharge slurry from the said autoclave; and means for providing and contacting cooling fluid by addition of the cooling fluid with the autoclave discharge slurry prior to its entry into the first flash vessel

28. The arrangement as claimed in claim 27, wherein the arrangement comprises an autoclave (1) arranged for pressure oxidation or high pressure acid leaching of metal containing ore or concentrate; a first flash vessel (2) arranged for converting the heat of the autoclave discharge slurry into a first flash steam and a first cooled slurry and connected to the autoclave via an autoclave discharge line (101) for receiving autoclave discharge slurry from the said autoclave; a recycling line (103) connected to the first flash vessel (2) and the autoclave discharge line (101) for providing a portion of the cooled slurry and contacting it with the autoclave discharge slurry prior to its entry into the first flash vessel (2).

29. The arrangement as claimed in claim 28, wherein the arrangement further comprises a solid/liquid separation device (6) connected to the first flash vessel (2) for receiving the cooled slurry from the said first flash vessel and arranged for separating part or all of the solids comprised in the said cooled slurry from the liquids to obtain a first concentrated cooled slurry and first cooled liquor, and further connected to the autoclave discharge line (101) for recycling a portion of the first cooled liquor and contacting it with the autoclave discharge slurry prior to its entry into the first flash vessel (2).

30. The arrangement as claimed in claim 29, wherein the solid/liquid separating device (6) is connected to the autoclave discharge line (101) via a liquor discharge line (105) which is divided into a recycling line (103) which is connected to the autoclave discharge line (101) for recycling a portion of the first cooled liquor a portion and contacting it with the autoclave discharge slurry prior to its entry into the first flash vessel (2), and to a liquor recovery line (107) for recovering the remaining portion of the first cooled liquor.

31. The arrangement as claimed in claim 27, wherein the arrangement comprises an autoclave (1) arranged for pressure oxidation or high pressure leaching of metal containing ore or concentrate; a first flash vessel (2) connected to the autoclave (1) for receiving autoclave discharge slurry from the said first autoclave and arranged for converting the heat of the autoclave discharge slurry into a first flash steam and a first cooled slurry; an inlet (9) connected to the last compartment (10) of the autoclave (1) and arranged for providing cooling fluid to the said last compartment (10) for precooling of the autoclave discharge slurry.

32. The arrangement as claimed in claim 27, wherein the arrangement further comprises a second flash vessel connected to the first flash vessel and arranged for converting the first cooled slurry obtained from the first flash vessel to a second flash steam and a second cooled slurry.
